(19) United States
(12) Patent Application Publication
(10) Pub. No.: US 2002/0054734 A1
(43) Pub. Date: May 9, 2002

(54) Wavelength monitor apparatus and wavelength stabilizing light source

(76) Inventors: Kenji Masuda, Tokyo (JP); Makoto Sato, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/895,261

(22) Filed: Jul. 2, 2001

(30) Foreign Application Priority Data
Nov. 9, 2000 (JP) 2000-342076

(51) Int. Cl. G02B 6/26; H01S 3/13

(52) U.S. Cl. 385/31; 372/29.02

(57) ABSTRACT

In a wavelength monitor apparatus, a wavelength filter whose wavelength transmission property continuously changes in accordance with an incidence angle is disposed on a laser light axis, and a transmitted light of the wavelength filter is optically connected to a light receiving element. The wavelength filter is vibrated by a piezoelectric element, and the incidence angle is slightly vibrated. An output signal from a light emitting element is supplied to a lock-in amplifier, and the lock-in amplifier uses a drive signal of the piezoelectric element as a reference signal and monitors a frequency of the output signal. A signal from the lock-in amplifier is supplied to a drive controller, and a wavelength of the light emitting element is adjusted.

### BACKGROUND OF THE INVENTION

1. Field of the Invention

The present invention relates to a wavelength monitor apparatus enabling monitoring of a wavelength of a laser light, a wavelength stabilizing light source using the wavelength monitor apparatus, and a wavelength detecting method.

2. Description of Related Art

### CONVENTIONAL EXAMPLE 1

An example of a known wavelength monitor apparatus is shown in FIG. 7. FIG. 7 is a diagram showing an outline of the wavelength detection apparatus described in, for example, publication B-10-180 from the 1998 General Meeting of the Electronic Information Communication Society. In FIG. 7, reference numerals 16, 17 denote first and second beam splitters for branching an input light, 18, 19 denote Fabry-Perot etalons (hereinafter referred to as FP etalons) having different wavelength transmission properties, and 20, 21 denote first and second light receiving elements. The first and second light receiving elements 20, 21 are disposed in positions at which the lights branched by the first and second beam splitters 16, 17 are received, and the first and second FP etalons 18, 19 are disposed between the first and second beam splitters 16, 17 and the first and second light receiving elements 20, 21, respectively.

In the conventional wavelength monitor apparatus shown in FIG. 7, the portion of the input light branched by the first beam splitter 16 is transmitted through the first FP etalon 18 and received by the first light receiving element 20. Similarly, the portion of the input light branched by the second beam splitter 17 is transmitted through the second FP etalon 19 and received by the second light receiving element 21. With such a configuration, because the first and second FP etalons 18, 19 have different transmittances in accordance with the input wavelength, output signal strengths of the first and second light receiving elements 20, 21 are dependent on wavelength. Therefore, a wavelength change of the input light can be measured as a change of the output signal strength from the first and second light receiving elements 20, 21. Moreover, since the first and second FP etalons 18, 19 have respective different wavelength transmission properties, a difference between the output signal intensities of the first and second light receiving elements 20, 21 is obtained, which becomes zero at a wavelength at which the transmittances of the FP etalons are equal, that is, at a point at which the wavelength transmission properties intersect each other. Then, a wavelength change amount is obtained with a positive/negative sign based on the wavelength.

### EXAMPLE 2

A second example of a known wavelength monitor apparatus is shown in FIG. 8. FIG. 8 is a diagram showing an outline of the wavelength monitor apparatus described in, for example, U.S. Pat. No. 5,825,792. In FIG. 8, reference numeral 22 denotes a light emitting element, 23 denotes an optical lens for adjusting a spread of the output signal from the light emitting element 22, 24 denotes an FP etalon, 25 denotes a first light receiving element, and 26 denotes a second light receiving element. The first and second light receiving elements 25, 26 are fixed on a common carrier 27, and the optical lens 23 and FP etalon 24 are disposed between an output surface of the light emitting element 22 and the first and second light receiving elements 25, 26. The output signals from the first and second light receiving elements 25, 26 are input to a subtractor 28, and the output signal of the subtractor is fed back to the light emitting element.

In the conventional wavelength monitor apparatus shown in FIG. 8, a part of the output light from the light emitting element 22 is passed through the optical lens 23 and FP etalon 24, and received by the first and second light receiving elements 25, 26. Because the transmittance of the FP etalon 24 differs with the input wavelength, the output signal strengths of the first and second light receiving elements 25, 26 are dependent on the wavelength. Therefore, the wavelength change of the output light of the light emitting element 22 can be measured as the change of output signal strength from the first and second light receiving elements 25, 26. Moreover, as shown in FIG. 8, when the FP etalon 24 is inclined with respect to a surface vertical to the light axis of the output light of the light emitting element 22, the incidence angle upon the FP etalon 24 differs with the position of the output light of the light emitting element 22, and the wavelength transmission property accordingly changes. When the first and second light receiving elements 25, 26 are disposed at two appropriate points with respect to the FP etalon 24, the output signals of the elements indicate different wavelength properties. This information can be utilized to obtain signals having two types of wavelength properties with a single FP etalon, without requiring an FP etalon having two different wavelength properties. While an inclination of the FP etalon 24 is fixed with respect to a wavelength λ0 to be stabilized, the positions of the first and second light receiving elements 25, 26 are adjusted so as to equalize the output signal strengths of the first and second light receiving elements 25, 26. When a difference between two output signal strengths is obtained by the subtractor 28, the strength of the difference signal becomes zero at the wavelength λ0, and an error signal having a positive/negative sign is obtained at the wavelength in the vicinity of λ0. When the error signal is fed back to the light emitting element 22, the wavelength can be stabilized at λ0.

In the wavelength monitor apparatus described above in Conventional Example 1, two beam splitters, two FP etalons, and two light receiving elements are used, and the number of optical components is large. Moreover, because two beam splitters are used, the number of light axes increases, and it is disadvantageously difficult to adjust the multiple light axes.

In the wavelength monitor apparatus described above in Conventional Example 2, the FP etalon is inclined with respect to the light axis, the output signal having two types of wavelength properties is obtained, and the number of optical components is therefore less than that of the Conventional Example 1. However, a spread angle of the output light of the light emitting element and an FP etalon positional relation determine the wavelength transmission property. Therefore, there is a problem that a high precision is required for the positions of the optical lens and two light receiving elements for determining the spread angle on the light axis, and the position and inclination angle of the FP etalon on the light axis. Moreover, the light receiving surface of the light receiving element itself has a certain size. Therefore, the angle at which light output from the light emitting element incident upon the light receiving surface will passing through the FP etalon varies according to the position at which it is incident upon the light receiving surface. The wavelength property of the output signal indicates an average of the wavelength properties over the light receiving surface. Therefore, a problem occurs in that the wavelength of the output signal is not precise.

Moreover, in the wavelength monitor apparatuses constituted as described above in the Conventional Examples 1 and 2, the stabilized wavelength is limited to the value at which the output signal strengths of two light receiving elements become equal to each other. When the output signal strengths of two light receiving elements are stabilized at different wavelengths, an additional apparatus, such as an equivalent unit for adjusting the output signal strength or the like, must disposed outside the wavelength monitor apparatus.

### SUMMARY OF THE INVENTION

According to the present invention, there is provided a wavelength monitor apparatus comprising a wavelength filter which is disposed on a light axis of a laser light, and whose wavelength transmission property continuously changes in accordance with a relative positional relation with the laser light; drive means for driving the wavelength filter and periodically changing the relative positional relation; a light receiving element disposed in a position to which a transmitted light of the wavelength filter is optically connected; and signal processing means for processing a periodic output signal from the light receiving element based on the periodic change of the relative positional relation to detect a wavelength of the laser light.

Preferably, the wavelength filter is a filter whose wavelength transmission property continuously changes in accordance with an incidence angle of the laser light, and the drive means periodically changes an angle of the wavelength filter with respect to the light axis.

Moreover, the wavelength filter preferably includes an FP etalon.

Furthermore, it may be preferable for the wavelength filter to be a filter whose wavelength transmission property continuously changes in accordance with an incidence position of the laser light, and the drive means periodically to move the wavelength filter in a direction having a component which is vertical to the light axis.

Additionally, the drive means may include a piezoelectric element.

Moreover, the signal processing means may preferably use a drive signal of the drive means as a reference signal, and include a lock-in amplifier for detecting a peak value of the output signal from the light receiving element.

Furthermore, according to another aspect, the present invention may be configured as an apparatus comprising spectral means disposed on the light axis before transmission through the wavelength filter; a second light receiving element disposed at a position to which the light split by the spectral means is optically connected; and means for receiving the output signal from the second light receiving element, and adjusting a strength of the laser light.

Additionally, the present inventionprovides a wavelength stabilizing light source comprising a laser light source; the aforementioned wavelength monitor apparatus for detecting a wavelength of a back surface light of the laser light source; and drive control means for controlling an oscillation wavelength of the laser light source based on the wavelength detected by the wavelength monitor apparatus.

In the present invention, the wavelength stabilizing light source may further include an optical fiber for directing a front surface light of the laser light source.

Moreover, according to another aspect of the present invention, there is provided a method of detecting a wavelength of a laser light, comprising steps of periodically changing at least one of an incidence angle and an incidence position of the laser light with respect to a wavelength filter to change a wavelength transmission property; and detecting the wavelength of the laser light based on a change period of the incidence angle or the incidence position, and a strength change period of the laser light transmitted through the wavelength filter.

### BRIEF DESCRIPTION OF THE DRAWINGS

FIG. 1 is a diagram showing the constitution of a wavelength monitor apparatus and wavelength stabilizing light source according to a first embodiment of the present invention.

FIG. 2 is a graph showing a wavelength transmission property of an FP etalon according to the first embodiment of the present invention.

FIG. 3 is a graph showing a relation between an incidence angle and a signal strength in the first embodiment of the present invention.

FIG. 4 is a graph showing an output signal of a lock-in amplifier in the first embodiment of the present invention.

FIG. 5 is a diagram showing the constitution of a wavelength monitor apparatus and wavelength stabilizing light source according to a second embodiment of the present invention.

FIG. 6 is a graph showing the wavelength transmission property of a wavelength filter according to the second embodiment of the present invention.

FIG. 7 is a diagram showing the constitution of a wavelength monitor apparatus according to a first conventional example.

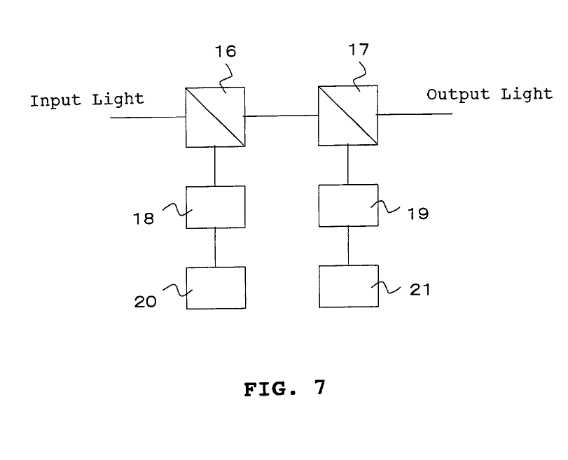

FIG. 8 is a diagram showing the constitution of a wavelength monitor apparatus according to a second conventional example.

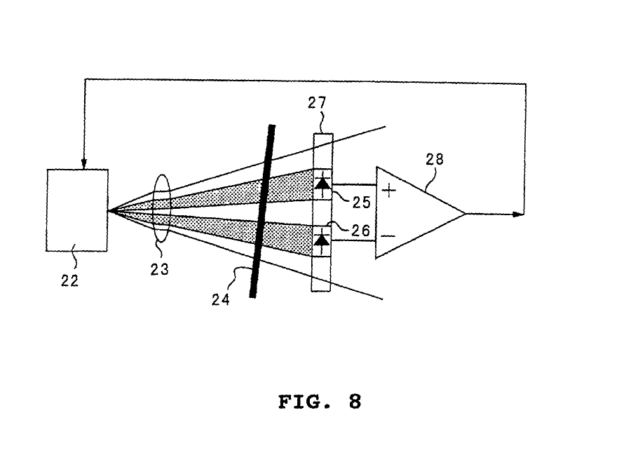

### DETAILED DESCRIPTION OF THE PREFERRED EMBODIMENTS

First Embodiment

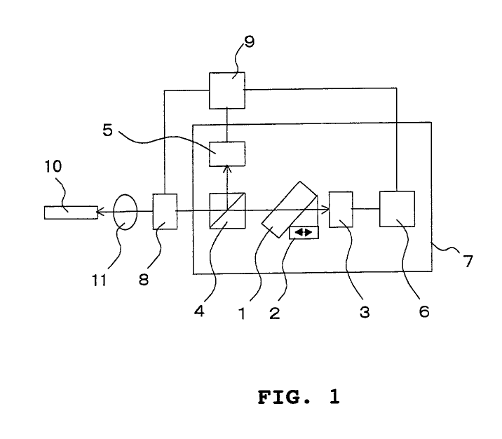

FIG. 1 is a diagram showing the constitution of a wavelength monitor apparatus and wavelength stabilizing light source according to a first embodiment of the present invention. In FIG. 1, reference numeral 1 denotes an FP etalon as a wavelength filter whose wavelength transmission property continuously changes in accordance with an incidence angle, 2 denotes a piezoelectric element as drive means of the FP etalon 1, or means for periodically changing a relative positional relation between an incident light and the wavelength filter, 3 denotes a first light receiving element, 4 denotes a beam splitter as spectral means, 5 denotes a second light receiving element, 6 denotes a lock-in amplifier, 7 denotes a wavelength monitor apparatus, 8 denotes a light emitting element such as a semiconductor laser, 9 denotes a drive controller of the light emitting element, 10 denotes an optical fiber, and 11 denotes an optical lens for connecting a front surface light of the light emitting element 8 to the optical fiber 10.

The wavelength stabilizing light source is constituted by the light emitting element 8, optical lens 11, optical fiber 10, wavelength monitor apparatus 7, and drive controller 9. A back surface light of the light emitting element 8 is input to the wavelength monitor apparatus 7, and an output signal indicating a wavelength fluctuation from the wavelength monitor apparatus 7 is input to the drive controller 9. The drive controller 9 is connected to the light emitting element 8, and controls drive conditions of the light emitting element 8 based on the output signal from the wavelength monitor apparatus 7.

The wavelength monitor apparatus 7 is constituted by the FP etalon 1, piezoelectric element 2, beam splitter 4, first and second light receiving elements 3, 5, and lock-in amplifier 6. The back surface light of the light emitting element 8 is spatially split by the beam splitter 4, one of the split light beams is optically connected to the first light receiving element 3 via the FP etalon 1, and the other light is optically connected to the second light receiving element 5, and the output signal obtained by the first light receiving element 3 having received the light is input to the lock-in amplifier 6. A relative position of the FP etalon 1 with respect to a light axis of the back surface light of the light emitting element, that is, an incidence angle, can be vibrated by the piezoelectric element 2.

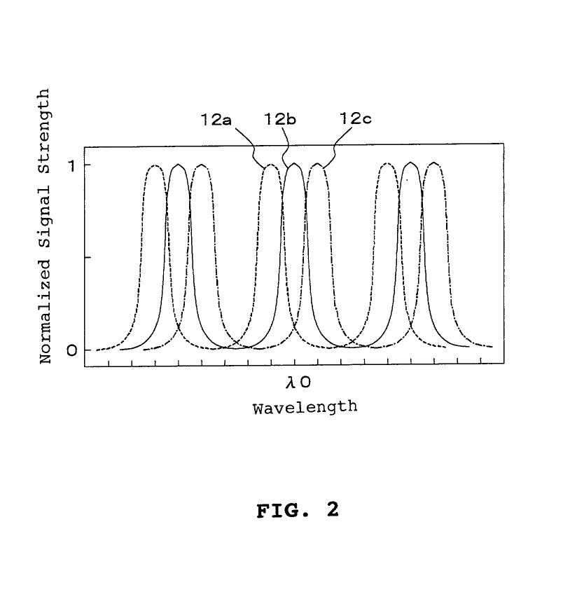

Operation of the example apparatus configured as described above will next be described. A wavelength transmission property of the FP etalon 1 is shown in FIG. 2. In FIG. 2, the abscissa indicates a wavelength, the ordinate indicates a normalized signal strength, and 12a, 12b, 12c indicate wavelength transmission properties for different incidence angles of the back surface light of the light emitting element. When the angle of the FP etalon 1 is slightly vibrated by the piezoelectric element 2, a transmission strength of the FP etalon 1 periodically changes with respect to the same wavelength, and an output signal strength of the first light receiving element 3 similarly periodically changes. For example, a stabilizing wavelength is set to λ0, a direct-current bias of the piezoelectric element 2 is controlled and the FP etalon 1 is held at the incidence angle at which the wavelength transmission property 12b is obtained. In such a case, a frequency component of the output signal of the first light receiving element 3 is twice that of a vibration signal of the piezoelectric element 2 in the wavelength λ0, that is, at a peak of the wavelength transmission property 12b, and becomes equal to that of the vibration signal of the piezoelectric element 2 at another wavelength.

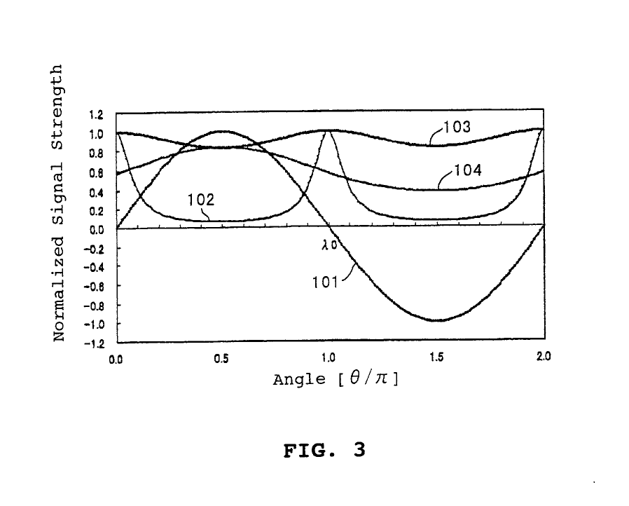

FIG. 3 shows a change of the normalized signal strength when the piezoelectric element 2 slightly vibrates the angle of the FP etalon 1. In FIG. 3, the abscissa indicates the incidence angle, the ordinate indicates the normalized signal strength, reference numeral 101 denotes a drive signal of the piezoelectric element 2, 102 denotes the wavelength transmission property of the FP etalon 1, 103 denotes a strength for the wavelength λ0, and 104 denotes a strength when the wavelength is not λ0. With the wavelength of λ0, a signal whose frequency is twice that of the drive signal of the piezoelectric element 2 is obtained. It is further seen that with the wavelength other than λ0 the signal having the same frequency as that of the drive signal of the piezoelectric element 2 is obtained.

Here, the drive signal of the piezoelectric element 2 and the output signal of the first light receiving element 3 are both supplied to the lock-in amplifier 6, and the drive signal of the piezoelectric element 2 is used as a reference signal. The lock-in amplifier 6 has a function of outputting a signal when receiving a signal synchronized with the reference signal, that is, the signal having the same frequency component as that of the reference signal. The lock-in amplifier also has a function of setting a signal output to zero when receiving a signal having a frequency component other than that of the reference signal. Therefore, the output signal of the lock-in amplifier 6 becomes zero when the frequency component of the output signal of the first light receiving element 3 is different from the frequency component of the reference signal, that is, when the wavelength is λ0.

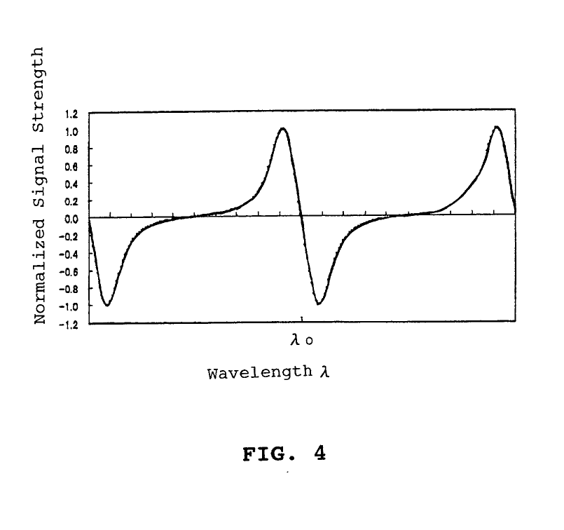

FIG. 4 shows an output signal change of the lock-in amplifier 6. In FIG. 4, the abscissa indicates a laser light wavelength, and the ordinate indicates the output signal strength of the normalized lock-in amplifier 6. When the wavelength is λ0, the frequency is different from that of the reference signal, and, therefore, the output signal of the lock-in amplifier is always zero. However, when the wavelength deviates from λ0, the output signal other than zero is obtained. Additionally, the frequency component of the output signal from the light receiving element 3 is dispersed with respect to the frequency component of the reference signal because of an inclination of the wavelength transmission property of the FP etalon 1. Therefore, the output signal of the lock-in amplifier 6 is maximized at the wavelength at which the inclination of the wavelength transmission property is maximized. Moreover, when the wavelength is smaller and larger than the wavelength λ0, a polarity of the output signal of the lock-in amplifier 6 is reversed. Therefore, whether the wavelength of the laser light is equal to, or smaller or larger than λ0 can be determined based on the output signal of the lock-in amplifier 6. Alternatively, the extent to which the wavelength is smaller or larger than λ0 can also be detected. Additionally, as seen from FIG. 4, even among the wavelengths other than λ0 there is a wavelength at which the output signal turns to zero. However, when a wavelength fluctuation range centering on λ0 in the semiconductor laser is considered, the wavelength can be determined univocally. Moreover, when the output signal of the lock-in amplifier 6 is inputted to the drive controller 9, an oscillation wavelength of the light emitting element 8 can be controlled to be constant.

Moreover, when the direct-current bias of the piezoelectric element 2 is changed and the incidence angle upon the FP etalon is adjusted, the stabilizing wavelength can finitely and arbitrarily be changed.

Furthermore, when the wavelength transmission property of the FP etalon 1 periodically has a peak, the wavelength can also be stabilized at the adjacent peak.

On the other hand, the output of the second light receiving element 5 indicates a relative strength of the back surface light which is in a proportional relation with the front surface light of the light emitting element 8, regardless of the wavelength. Therefore, when the output of the second light receiving element is input to the drive controller 9, the output of light from the optical fiber 10 can be maintained at a constant strength.

The drive controller 9 adjusts a light emitting element injection current, temperature, resonator length, and periodic diffraction grating interval based on the output signal of the wavelength monitor apparatus 7, and can control the oscillation wavelength and light output strength.

Second Embodiment

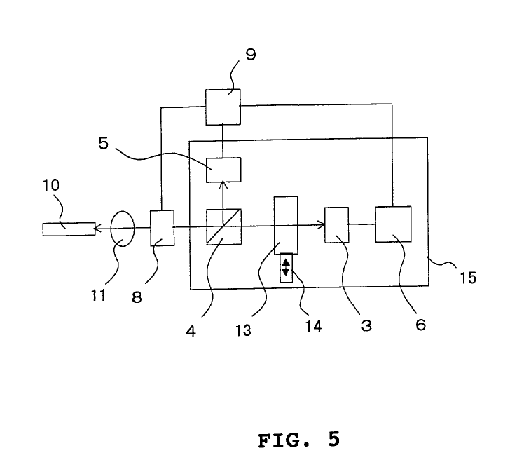

FIG. 5 is a diagram of the wavelength monitor apparatus and wavelength stabilizing light source according to a second embodiment of the present invention. Components corresponding to those of FIG. 1 are denoted with the same reference numerals and their description will not be repeated. In FIG. 5, reference numeral 13 denotes a wavelength filter whose wavelength transmission property continuously changes in accordance with an incidence position, 14 denotes a piezoelectric element as drive means for periodically changing a relative positional relation of the wavelength filter 13 to an incident light, and 15 denotes a wavelength monitor apparatus. Here, the wavelength monitor apparatus 15 has a constitution similar to that of FIG. 1, except that the incidence position of the back surface light of the light emitting element 8 upon the wavelength filter 13 is vibrated by the piezoelectric element 14. Moreover, the wavelength filter 13 is constituted by, for example, a plate glass and an optical thin film formed on the surface of the plate glass with a tapered distribution, so that a transmission wavelength can continuously change in accordance with the incidence position.

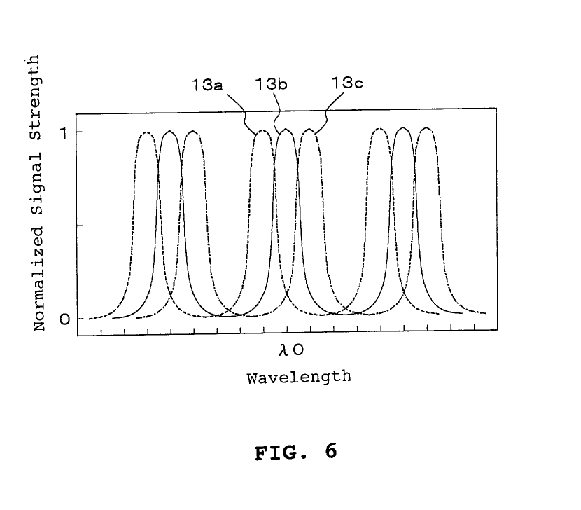

FIG. 6 shows a wavelength transmission property of the wavelength filter 13 when the wavelength filter 13 is slightly vibrated in a vertical direction (the up and down direction of FIG. 5) with respect to the light axis. In FIG. 6, reference numerals 13a, 13b, 13c denote wavelength transmission properties for respective different incidence positions. A change of the position of incidence upon the wavelength filter 13 becomes equal to a change of an optical length passed through the optical thin film in the wavelength filter 13. A wavelength difference Δv (free spectrum interval) between two adjacent peak strengths is inversely proportional to an optical length d. Therefore, when the optical length increases, Δv decreases. As a result, a peak wavelength in the vicinity of the specific wavelength λ0 shifts to a short wavelength range. On the other hand, when the optical length decreases, the peak wavelength in the vicinity of λ0 shifts to a long wavelength range. Therefore, the incidence position in which the transmission property reaches its peak at the wavelength λ0 is used as a reference position. The wavelength filter 13 is moved in a direction in which the optical length increases, and the wavelength transmission property 13a of FIG. 6 is indicated. The wavelength filter 13 is moved in a direction in which the optical length decreases, and the wavelength transmission property 13c of FIG. 6 is then indicated.

Therefore, when the wavelength filter 13, including the reference position, is slightly vibrated as in the first embodiment, the signal having the frequency twice that of the drive signal of the piezoelectric element 14 is obtained with the wavelength of λ0, and the signal having the same frequency as that of the drive signal of the piezoelectric element 14 is obtained with the wavelength other than λ0. Subsequently, the drive signal of the piezoelectric element 14 and the output signal of the first light receiving element 3 are both supplied to the lock-in amplifier 6, and the drive signal of the piezoelectric element 14 is used as the reference signal. In such a case, the lock-in amplifier 6 has a function of outputting the signal when receiving the signal synchronized with the reference signal, being the signal having the same frequency component as that of the reference signal, and a function of setting the signal output to zero when receiving the signal having a frequency component other than that of the reference signal. Therefore, the output signal of the lock-in amplifier 6 becomes zero when the frequency component of the output signal of the first light receiving element 3 is different from the frequency component of the reference signal, that is, when the wavelength is λ0. Thereby, the light emitting wavelength of the light emitting element 8 can be monitored. When the output signal of the lock-in amplifier 6 is supplied to the drive controller 9, and the drive controller 9 subjects the light emitting wavelength of the light emitting element 8 to feedback control, the light emitting wavelength can be adjusted to obtain the specific wavelength λ0.

Additionally, although in the example apparatus of the second embodiment, the wavelength filter 13 is slightly vibrated in the direction vertical to the light axis, the direction need not be vertical. The filter may, for example, be slightly vibrated in a direction oblique to the light axis. However, because when the wavelength filter 13 is driven along the light axis no factor is varied, the filter should be vibrated in a direction of a vector having a component vertical to the light axis.

As described above, according to the present invention, because the wavelength monitor apparatus can be constituted by one wavelength filter and light receiving element, the number of optical components can be minimized, and adjustment of the light axis and arrangement of the components is simplified.

Moreover, when the lock-in amplifier is used, wavelength fluctuation can be detected with a high precision and a high S/N ratio.

Furthermore, the reference position of the drive means, for example, the direct-current bias of the piezoelectric element may be changed, and the relative position with respect to the wavelength filter, for example, the incidence angle or the incidence position may be adjusted. In this way, the stabilizing wavelength can be finitely and arbitrarily selected, such that the invention can process a large variety of wavelengths from various light sources.

What is claimed is:

1. A wavelength monitor apparatus comprising:
a wavelength filter which is disposed on the light axis of a laser light, and whose wavelength transmission property continuously changes in accordance with a relative positional relation with the laser light;
drive means for driving said wavelength filter and periodically changing said relative positional relation;
a light receiving element disposed in a position to which a transmitted light of said wavelength filter is optically connected; and
signal processing means for processing a periodic output signal from said light receiving element based on the periodic change of said relative positional relation to detect a wavelength of said laser light.

2. The apparatus according to claim 1, wherein
said wavelength filter is a filter in which said wavelength transmission property continuously changes in accordance with the incidence angle of laser light, and
said drive means periodically changes an angle of said wavelength filter with respect to said light axis.

3. The apparatus according to claim 1, wherein
said wavelength filter includes a Fabry-Perot etalon.

4. The apparatus according to claim 1, wherein
said wavelength filter is a filter in which said wavelength transmission property continuously changes in accordance with the incidence position of laser light, and
said drive means periodically moves said wavelength filter in a direction having a component which is vertical to said light axis.

5. The apparatus according to claim 1, wherein
said drive means includes a piezoelectric element.

6. The apparatus according to claim 1, wherein
said signal processing means uses a drive signal of said drive means as a reference signal, and includes a lock-in amplifier for detecting a peak value of the output signal from said light receiving element.

7. The apparatus according to claim 1, further comprising:
spectral means disposed on said light axis before transmission through said wavelength filter;
a second light receiving element disposed at a position to which the light split by said spectral means is optically connected; and
means for receiving the output signal from said second light receiving element, and adjusting a strength of said laser light.

8. A wavelength stabilizing light source comprising:
a laser light source;
the wavelength monitor apparatus according to claim 1 for detecting a wavelength of a back surface light of said laser light source; and
drive control means for controlling an oscillation wavelength of said laser light source based on the wavelength detected by said wavelength monitor apparatus.

9. The wavelength stabilizing light source according to claim 8, further comprising:
an optical fiber for directing a front surface light of said laser light source.

10. A method of detecting a wavelength of a laser light, comprising steps of:
periodically changing at least one of an incidence angle and an incidence position of the laser light with respect to a wavelength filter to change a wavelength transmission property; and
detecting the wavelength of said laser light based on a change period of said incidence angle or said incidence position, and a strength change period of the laser light transmitted through said wavelength filter.
